(19) United States
(12) Patent Application Publication
(10) Pub. No.: US 2026/0147356 A1
(43) Pub. Date: May 28, 2026

(54) ROBOT CONTROL METHOD, ELECTRONIC DEVICE, AND COMPUTER-READABLE STORAGE MEDIUM

(71) Applicant: UBTECH ROBOTICS CORP LTD, Shenzhen (CN)

(72) Inventors: YUFAN PI, Shenzhen (CN); Youfang Lai, Shenzhen (CN); Huanyu Wen, Shenzhen (CN); Jichao Jiao, Shenzhen (CN)

(21) Appl. No.: 19/325,526

(22) Filed: Sep. 11, 2025

(30) Foreign Application Priority Data
Nov. 22, 2024 (CN) 202411681972.1

(51) Int. Cl. G05D 1/644; G05D 101/00

(52) U.S. Cl. CPC G05D 1/644; G05B 2219/39001; G05D 2101/00

(57) ABSTRACT

A robot control method, an electronic device, and a computer-readable storage medium are provided. The method includes: constructing, based on a historical control parameter sequence of the robot within a historical time step, a Gaussian distribution of control parameters of the robot; obtaining, by randomly sampling the Gaussian distribution, M sampling control parameter sequences, where M is an integer larger than 1; determining, based on a pre-built cost equation for a motion trajectory of the robot, a cost of each of the M sampling control parameter sequences; determining, based on the cost of each of the M sampling control parameter sequence and the M sampling control parameter sequences, a target control parameter sequence; and performing, according to the target control parameter sequence, a motion control on the robot. In this manner, the efficiency of motion control for robots can be improved.

### CROSS REFERENCE TO RELATED APPLICATIONS

The present disclosure claims priority to Chinese Patent Application No. 202411681972.1, filed Nov. 22, 2024, which is hereby incorporated by reference herein as if set forth in its entirety.

### TECHNICAL FIELD

The present disclosure relates to robotics technology, and particularly to a robot control method, an electronic device, and a computer-readable storage medium.

### BACKGROUND

Due to the uncertainty of the dynamics of robots and their interaction with other intelligent entities, the motion planning in complex environments for the autonomous robots faces many challenges, such as dynamic obstacle avoidance, multi-robot coordination, and the like. In addition, due to hardware limitations, there are difficulties in realizing methods using high computing power, which affect the performance and the efficiency of motion control for robots.

### BRIEF DESCRIPTION OF DRAWINGS

FIG. 1 is a schematic diagram of an optional architecture of a robot control system according to an embodiment of the present disclosure.

FIG. 2 is a schematic diagram of the structure of an electronic device according to an embodiment of the present disclosure.

FIG. 3 is a flow chart of an optional flow of a robot control method according to an embodiment of the present disclosure.

FIG. 4 is a flow chart of constructing a Gaussian distribution according to an embodiment of the present disclosure.

FIG. 5 is a flow chart of randomly sampling the Gaussian distribution according to an embodiment of the present disclosure.

FIG. 6 is a flow chart of determining a target control parameter sequence according to an embodiment of the present disclosure.

FIG. 7 is a flow chart of determining a weight coefficient of each of the M sampling control parameter sequences according to an embodiment of the present disclosure.

FIG. 8 is a flow chart of determining a target control parameter sequence according to another embodiment of the present disclosure.

FIG. 9 is a flow chart of performing a motion control on a robot according to an embodiment of the present disclosure.

FIG. 10 is a flow chart of solving an optimization equation according to an embodiment of the present disclosure.

### DETAILED DESCRIPTION

In order to make the purpose, technical solutions, and advantages of the present disclosure clearer, it will be further described in detail below regarding the drawings. The described embodiments should not be regarded as limiting the present disclosure. Instead, all other embodiments obtained by those skilled in the art without making creative work are within the protection scope of present disclosure.

In the following descriptions, “some embodiments” are involved, which describe all possible embodiments, but it should be noted that “some embodiments” may also be the same subset or different subsets of all possible embodiments and may be combined with each other where no conflict therebetween.

In the embodiments of the present disclosure, the term “module” or “unit” refers to an entirety of a computer program with predetermined functions or a part of the computer program that works with other related parts to achieve predetermined goals, which may be implemented in whole or in part by using software, hardware (e.g., processing circuits or storage), or a combination thereof. Similarly, a processor (or a plurality of processors or memories) may be used to implement one or more modules or units. In addition, each module or unit may be part of an integral module or unit containing the functions of the module or unit.

Unless otherwise defined, all technical and scientific terms used in the embodiments of present disclosure are the same as commonly understood by those skilled in the art. The terms used in the embodiments of present disclosure are just for describing the embodiments of present disclosure, rather than limiting the present disclosure.

In the embodiments of the present disclosure, the relevant data collection and processing should be strictly based on the requirements of relevant laws and regulations and obtain the informed consent or separate consent of the subject of personal information, and should carry out subsequent data use and process within the scope of the authorization of laws, regulations, and the subject of personal information.

Before further detailed description of the embodiments of the present disclosure, the involved nouns and terms will be described as follows.

1) Model predictive control (MPC): A control algorithm that uses the mathematical model of a system to predict the behavior of the system within a period in the future, and optimizes the control input based on these prediction results and the current system state to achieve specific control goals. For example, MPC can be applied in robot control, which continuously predicts the behaviors of a robot within a period in the future using the current state information of the robot, and construct an optimization equation based on these prediction information. Through the optimization equation, the optimal control strategy is found for enabling the robot to meet specific control goals.

2) Time step: The limited prediction time range in time domain, also known as “rolling horizon”. For example, in MPC, rolling horizon refers to a time window for prediction and optimization, which covers the behaviors of the robot for a period of time starting from the current moment. The time window will move forward continuously as the time progresses, that is, moving forward one moment each time.

The computational complexity of optimization problems usually increases with the increase of the number of optimization variables (i.e., control parameters). For example, in robot control, as the number of robot joints increases, the number of sub-parameters in each control parameter of a control parameter sequence will also increase, making the optimization problem more complex. Moreover, robot control systems are usually highly nonlinear and may cause the objective functions and constraints to have complex mathematical properties, resulting in the need of more computing resources when performing motion control on robots.

The embodiments of the present disclosure provide a robot control method, an robot control apparatus, an electronic device, a computer-readable storage medium, and a computer program product, which can improve the efficiency of motion control for robots. The following exemplifies the application of the electronic device provided by the embodiments of the present disclosure. The electronic device may be implemented as various type of terminal like a laptop computer, a tablet computer, a desktop computer, a set-top box, a smartphone, a smart speaker, a smart watch, a smart TV, a car terminal, a robot, or implemented as a server.

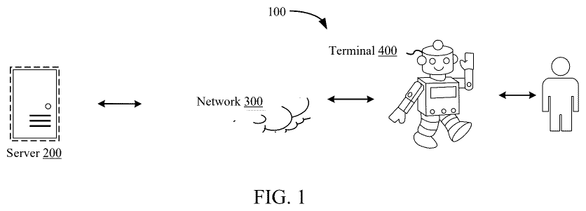

FIG. 1 is a schematic diagram of an optional architecture of a robot control system 100 according to an embodiment of the present disclosure. As shown in FIG. 1, in order to implement an application that supports robot motion control with improved efficiency, in the system 100, there is a terminal 400 (e.g., a humanoid robot or a sweeping robot) connecting to a server 200 (e.g., the electronic device) through a network 300 that may be a wide area network or a local area network, or a combination of the two.

The server 200 is configured to construct, based on a historical control parameter sequence of the terminal 400 within a historical time step, a Gaussian distribution of control parameters of the terminal 400; obtain, by randomly sampling the Gaussian distribution, M sampling control parameter sequences, where M is an integer larger than 1; determining, based on a pre-built cost equation for a motion trajectory of the terminal 400, a cost of each of the M sampling control parameter sequences; determining, based on the cost of each of the M sampling control parameter sequence and the M sampling control parameter sequences, a target control parameter sequence; and performing, according to the target control parameter sequence, a motion control on the terminal 400. The terminal 400 is configured to move based on the target control parameter sequence.

In some embodiments, the server 200 may be a stand-alone physical server, or a server cluster or distributed system composed of multiple physical servers, or may also be a cloud server providing cloud service, cloud database, cloud computing, cloud function, cloud storage, network service, cloud communication, middleware service, domain name service, security service, content delivery network (CDN), and basic cloud computing service such as big data and artificial intelligence platform. The terminal 200 and the server 200 may be connected directly or indirectly through wired or wireless communication.

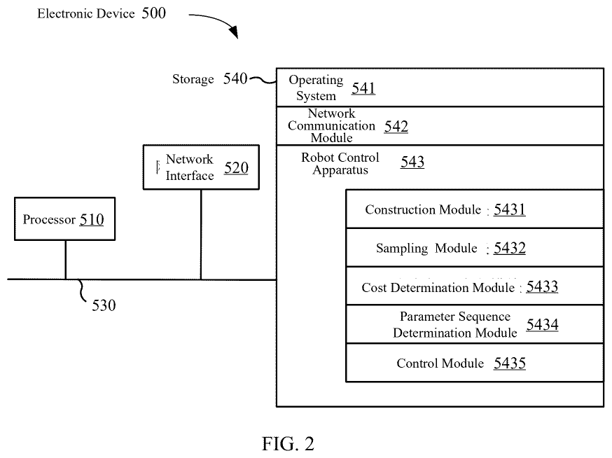

FIG. 2 is a schematic diagram of the structure of an electronic device 500 according to an embodiment of the present disclosure. As shown in FIG. 2, the electronic device 500 may be a server. The electronic device 500 may include at least one processor 510, a storage 540 and at least one network interface 520. The various components in the electronic device 500 may be coupled together through a bus system 530. It should be noted that the bus system 530 is used to realize the connection communication between these components. In addition to data bus, the bus system 530 also includes a power bus, a control bus, and a status signal bus. However, for the sake of clarity, the various buses are marked as the bus system 530 in FIG. 2.

The processor 510 may be an integrated circuit chip with signal processing capabilities, which may be, for example, a general-purpose processor, a digital signal processor (DSP), or other programmable logic device, discrete gate or transistor logic device, discrete hardware component, or the like. In which, the general-purpose processor may be a microprocessor, any conventional processor, or the like.

The storage 540 may include removable part, non-removable part, or a combination thereof. In hardware, for example, the storage 540 may include solid state memory, hard disk drive, optical disk drive, or the like. The storage 540 may optionally include one or more storage devices physically located away from the processor 510. The storage 540 may include volatile memory, nonvolatile memory, or both. The nonvolatile memory may be read-only memory (ROM), and the volatile memory may be random access memory (RAM). In this embodiment, the storage 540 is intended to include any suitable type of storages. In some embodiments, the storage 540 is able to store data to support various operations. The data may include, for example, programs, modules, data structures, or subsets or supersets thereof, as described below.

An operating system 541 including system programs for processing various basic system services and performing hardware-related tasks, such as framework layer, core library layer, and driver layer that are for realizing various basic services and processing hardware-based tasks. A network communication module 542 configured to reach other electronic devices via the (wired or wireless) network interfaces 520. For example, the network interface 520 may include Bluetooth, wireless compatibility authentication (Wi-Fi), universal serial bus (USB), and the like. In some embodiments, the robot control apparatus may be implemented in software. As shown in FIG. 2, a robot control apparatus 543 is stored in the storage 540, which may be software in the form of program, plug-in, or the like, and may include the following software modules: a construction module 5431, a sampling module 5432, a cost determination module 5433, a parameter sequence determination module 5434, and control module 5435. Since these modules are logical, any combination or further split may be performed according to the implemented functions. The function of each module will be described below.

In other embodiments, the robot control apparatus may be implemented in hardware. For example, the robot control apparatus may be a processor of the type of hardware decoding which is programmed to perform the robot control method. For example, the processor of the type of hardware decoding may adopt one or more application specific integrated circuits (ASICs), digital signal processors (DSPs), programmable logic devices (PLDs), complex programmable logic devices (CPLDs), field-programmable gate arrays (FPGAs), and other electronic components.

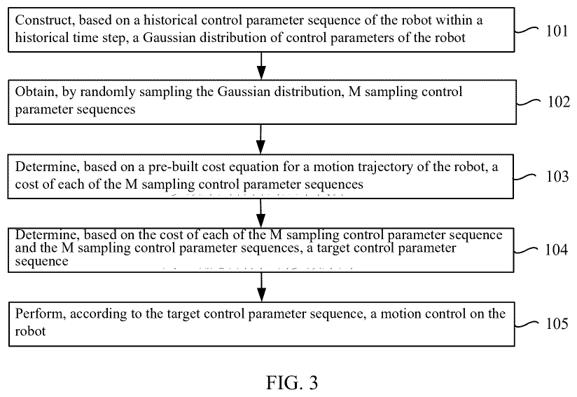

The robot control method provided by the embodiments of present disclosure will be explained in connection with the exemplary application and implementation of the electronic device provided by the embodiments of present disclosure. In this embodiment, the robot control method will be explained by taking a server as the subject of execution. FIG. 3 is a flow chart of an optional flow of a robot control method according to an embodiment of the present disclosure. In this embodiment, the control method is applied to the robot control system as shown in FIG. 1 that is for a robot (e.g., a humanoid robot or a wheeled robot). In other embodiments, the method may be implemented through the electronic device as shown in FIG. 2. As shown in FIG. 1, the control method may include the following steps.

101: constructing, based on a historical control parameter sequence of the robot within a historical time step, a Gaussian distribution of control parameters of the robot.

A control parameter sequence is a sequence of control parameters of the robot. In some examples, it may utilize the principle of MPC to predict the future behavior (i.e., the control parameter sequence) of the robot. MPC predicts the behavior of the robot for a period of time (i.e., one time step) at the current moment. The time step usually contains a plurality of moments (each moment corresponds to one control parameter). Over time, MPC will update the prediction, that is, it only moves forward one moment at a time and re-predict at the new current moment. This prediction process of continuous update is called “rolling”, and the time step is also called “rolling horizon”.

Each control parameter sequence may be expressed using an equation of:

$$U = [ {u}_{0} , {u}_{1} , {u}_{2} , … , {u}_{N - 1} ] \qquad ( 1 )$$

In which, U is the control parameter sequence within the time step of the current moment of prediction; u₀ is the control parameter of the initial moment (i.e. the first moment) within the time step of prediction; u₁ is the control parameter of the second moment within the time step of prediction; u₂ is the control parameter of the third moment within the time step of prediction; and u_{N-1} is the control parameter of the N-th moment within the time step of prediction, where the range of the time step may be [0, N).

Each control parameter (which may be expressed as uₖ, and the range of k is [0, N)) may have a plurality of dimensions, and may include at least one sub-parameter. For example, if the robot is a plane robot, it may include the control parameters such as the translation of the x-axis and y-axis, and the rotation of the z-axis. Each control parameter may also include the joint angles of a robotic arm of the robot, for example, uₖ may be the translation speed, angular velocity, acceleration, angular acceleration, or the like of the x-axis.

Furthermore, the historical control parameter sequence is the control parameter sequence within the time step corresponding to the previous moment with respect to the current moment, which may be expressed using an equation of:

$${U}^{t - 1} = [ {u}_{0}^{t - 1} , {u}_{1}^{t - 1} , {u}_{2}^{t - 1} , … {u}_{N - 1}^{t - 1} ] \qquad ( 2 )$$

In which, U^{t-1} is the historical control parameter sequence,

$${u}_{0}^{t - 1}$$

is the control parameter at the initial moment within the time step corresponding to the previous moment;

$${u}_{1}^{t - 1}$$

is the control parameter at the second moment within the time step corresponding to the previous moment;

$${u}_{2}^{t - 1}$$

is the control parameter at the third moment within the time step corresponding to the previous moment; and

$${u}_{N - 1}^{t - 1}$$

is the control parameter at the N-th moment within the time step corresponding to the previous moment, where the range of the time steps is [0, N).

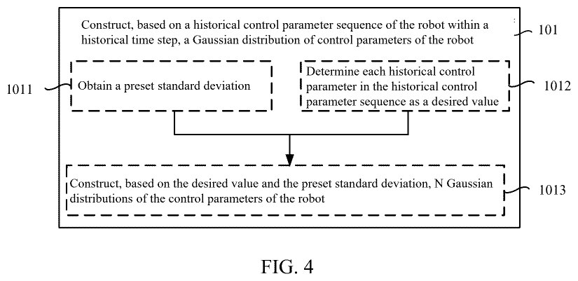

FIG. 4 is a flow chart of constructing the Gaussian distribution according to an embodiment of the present disclosure. Step 101 shown in FIG. 3 may be include the following steps 1011-1013, which will be explained in detail below.

1011: obtaining a preset standard deviation.

In this embodiment, the shape of the Gaussian distribution (also known as normal distribution) may be determined by the standard deviation of the Gaussian distribution. The larger the standard deviation, the more dispersed the Gaussian distribution and the wider the graph; otherwise, the smaller the standard deviation, the more concentrated the Gaussian distribution and the narrower the graph. The actual value of the preset standard deviation may be set according to actual needs, or according to priori knowledge.

1012: determining each historical control parameter in the historical control parameter sequence as a desired value.

In which, the historical control parameter sequence may include N historical control parameters, and Nis an integer larger than 1

In this embodiment, the historical control parameter sequence may include N historical control parameters, and each historical control parameter in the historical control parameter sequence may be determined as a desired value. For example, the N historical control parameters in the historical control parameter sequence U^{t-1} may be represented as

$${u}_{k}^{t - 1} , and {u}_{k}^{t - 1}$$

may be set as a desired value to obtain N desired values.

1013: constructing, based on the desired value and the preset standard deviation, N Gaussian distributions of the control parameters of the robot.

In this embodiment, the Gaussian distribution may also be determined according to the desired value (i.e., the mean) and standard deviation. These two basic parameters can define the shape and the position of the Gaussian distribution. The desired value is the center position of the Gaussian distribution, representing the mean of data. The standard deviation is a statistic amount that measures the degree of dispersion of the data points around the desired value, and is the square root of variance. The variance is the mean of the square of the difference between each data point and the desired value. Given a desired value and a standard deviation, the form of the Gaussian distribution can be determined. Therefore, after determining N desired values and the preset standard deviation, N Gaussian distribution of the control parameters of the robot can be constructed. For example, the desired value may be expressed as

$${u}_{k}^{t - 1} ,$$

the preset standard deviation may be expressed as σ, and the Gaussian distribution may be expressed using an equation of:

$${u}_{k} ∼ N ( {u}_{k}^{t - 1} , σ ) \qquad ( 3 )$$

where, uₖ is each control parameter in the control parameter sequence within the time step corresponding to the current moment;

$${u}_{k}^{t - 1}$$

is each historical control parameter in the historical control parameter sequence within the time step corresponding to the previous moment; and σ is the preset standard deviation.

Through steps 1011-1013, the Gaussian distribution can be constructed by taking each historical control parameter in the historical control parameter sequence within the historical time step as the desired value. The nature of the Gaussian distribution determines that most of the sampled values of the sampling control parameter sequence are concentrated near the historical control parameter sequence, reducing the possibility that the robot control parameters suddenly change to the extreme values that could lead to motion instability, and ensuring the stability of the control parameters of the robot that are predicted based on the Gaussian distribution.

As shown in FIG. 3, there are steps after the above-mentioned step 101 to be explained as follows.

102: obtaining, by randomly sampling the Gaussian distribution, M sampling control parameter sequences.

In which, Mis an integer larger than 1.

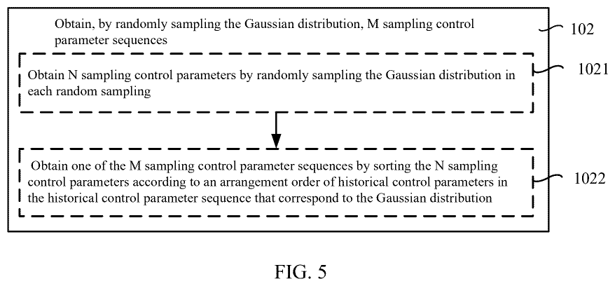

FIG. 5 is a flow chart of randomly sampling the Gaussian distribution according to an embodiment of the present disclosure. As shown in FIG. 5, in some embodiments, step 102 shown in FIG. 3 may include the following steps 1021-1022, which will be explained in detail below.

1021: obtaining N sampling control parameters by randomly sampling the Gaussian distribution in each random sampling.

In this embodiment, in each random sampling with respect to the Gaussian distribution, it is necessary to randomly sample the N Gaussian distributions obtained in step 1013 in sequence to obtain the N sampling control parameters. For example, the expression corresponding to the N Gaussian distributions is equation (3), and a random function may be designed for obtaining the N sampling control parameters (i.e., u₀, u₁, u₂, . . . , u_{N-1}) based on equation (3).

1022: obtaining one of the M sampling control parameter sequences by sorting the N sampling control parameters according to an arrangement order of historical control parameters in the historical control parameter sequence that correspond to the Gaussian distribution.

In this embodiment, in the historical control parameter sequence U^{t-1}, the historical control parameters

$${u}_{k}^{t - 1}$$

may be arranged in the order of moment

$$( i . e . , {u}_{0}^{t - 1} , {u}_{1}^{t - 1} , {u}_{2}^{t - 1} , … {u}_{N - 1}^{t - 1} )$$

within the time step, and a Gaussian distribution is constructed corresponding to each historical control parameter

$${u}_{k}^{t - 1} .$$

The sampling control parameter uₖ obtained by random sampling each Gaussian distribution also need to be sorted in the order of the arrangement of the historical control parameters

$${u}_{k}^{t - 1}$$

corresponding to the Gaussian distribution in the historical control parameter sequence

$${u}_{k}^{t - 1}$$

to obtain the sampling control parameter sequence (i.e., u₀, u₁, u₂, . . . , u_{N-1}).

Through repeating steps 1021-1022 for performing M random sampling, the M sampling control parameter sequence Uᵢ (i.e., U₁=[u_{1,0}, u_{1,1}, u_{1,2}, . . . , u_{1,N-1}], U₂=[u_{2,0}, u_{2,1}, u_{2,2}, . . . , u_{2,N-1}], . . . , U_{M}=[u_{M,0}, u_{M,1}, u_{M,2}, . . . , u_{M,N-1}]) of the robot can be obtained in parallel.

The M sampling control parameter sequences are converted into M robot trajectories W=[w₁, w₂, w₃, . . . , w_{M-1}] by using a first-order system to simulate the integral of the robot trajectories,

$${w}_{i} = {\sum }_{j = 0}^{N - 1} ( 1 - {e}^{\frac{- T}{τ}} ) {u}_{i , j} T$$

where, wᵢ represents the robot trajectory simulated by Uᵢ, e is the base of natural logarithm, T is the control period of the robot, and τ is a time constant typically 0.2 that is set according to the response speed of the robot.

Through steps 1021-1022, M sampling control parameter sequence can be randomly generated by performing random sampling on the Gaussian distribution. Subsequently, the optimal robot control parameter sequence can be solved using the generated M robot trajectories w and the M sampling control parameter sequences, thereby further reducing the computing power for solving the optimal control parameter sequence of the robot since it is a forward simulation belonging to 0-th order solving.

As shown in FIG. 3, there are steps after the above-mentioned step 102 to be explained as follows.

103: determining, based on a pre-built cost equation for a motion trajectory of the robot, a cost of each of the M sampling control parameter sequences.

In this embodiment, the cost equation for the motion trajectory of the robot needs to be constructed in advance by modeling the robot as a first-order system to simulate a trajectory by path integral. When constructing the cost equation for the robot, there are multiple cost factors needed to consider, including: motion cost, for example, trajectory tracking cost used to measure the deviation between the actual trajectory and the desired trajectory of the robot; speed and acceleration cost used to minimize changes in speed and acceleration to reduce energy consumption and improve motion smoothness; control cost, for example, control input cost used to measure the volume of the control signal to reduce the wear and the energy consumption of actuator; control change cost used to control the change rate of signal to reduce the impact and the uncertainty on the system; constraint cost, for example, input constraint cost used to ensure that the control input is physically feasible, such as not exceeding the maximum torque of motor; output constraint cost used to ensure that the behavior of the robot meets constraints, such as not exceeding the maximum speed or acceleration; environmental interaction cost, for example, obstacle avoidance cost used to ensure that the robot avoids collisions with obstacles during movement; terrain adaptation cost used to ensure that the adaption capability of the robot to terrain changes, such as going up and down slopes and crossing obstacles; task completion cost used to ensure that the robot can complete the given task such as transportation, assembly, and inspection; and time cost used to control the time required to complete the task which may direct effect the efficiency.

When constructing the cost equation, it may weight sum the cost factors according to actual needs to form a comprehensive cost function. The value of the weights used in weight sum may be set according to the requirements and the priorities for the specific application scenarios.

In some embodiments, after determining the cost factors of the robot, the cost equation of the motion trajectory of the robot may be constructed based on the cost factors. Then, the pre-constructed cost equation may be used by, for example calling the corresponding function to input each of the M sampling control parameter sequences into the pre-constructed cost equation, and the cost of each of the M sampling control parameter sequences can be obtained after calculation.

For example, the cost equation may be expressed using an equation of:

$$J = [ {a}_{N} + {\sum }_{i = 0}^{N - 1} ( q ( {w}_{i} ) + \frac{1}{2} {u}_{i}^{T} {Ru}_{i} ) ] \qquad ( 4 )$$

where, J is the cost of the motion trajectory of the robot; N is the limited prediction time range within the time step; α_{N} is the final state cost (e.g., the error cost with respect to the target position) of the control parameter sequence that is predicted through a physical mode of the robot; q(wᵢ) is the state execution cost that changes with time, which is the function of trajectory wᵢ; uᵢ is the control parameter that changes with time, which is multi-dimensional and, for the case of plane robot, may include the translation of the x-axis and the y-axis, and the rotation of the z-axis, and may also include the joint angle of the robotic arm of the robot. R is a positive-definite control weight matrix, and the sum

$$q ( {w}_{i} ) + \frac{1}{2} {u}_{i}^{T} {Ru}_{i}$$

within the time step represents the control execution cost of the robot during this time step. The control execution cost may include the distance cost to obstacles, the lubrication cost of the velocity trajectory, the trajectory tracking cost, the constraint cost of control sequence, and the like.

In this embodiment, the M sampling control parameter sequences Uᵢ of the robot may be substitute into equation (4) in sequence for calculation to obtain the cost (i.e., J₁, J₂, J₃, . . . , J_{M}) of each of the M sampling control parameter sequences.

104: determining, based on the cost of each of the M sampling control parameter sequence and the M sampling control parameter sequences, a target control parameter sequence.

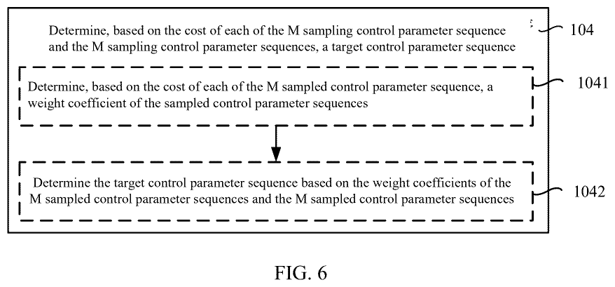

FIG. 6 is a flow chart of determining the target control parameter sequence according to an embodiment of the present disclosure. As shown in FIG. 6, in some embodiments, step 104 shown in FIG. 3 may include the following steps 1041-1042, which will be explained in detail below.

1041: determining, based on the cost of each of the M sampled control parameter sequence, a weight coefficient of the sampled control parameter sequences.

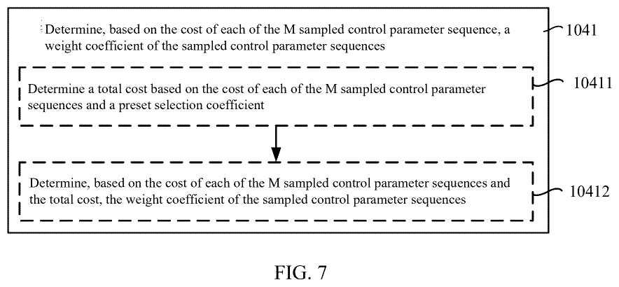

FIG. 7 is a flow chart of determining a weight coefficient of each of the M sampling control parameter sequences according to an embodiment of the present disclosure. As shown in FIG. 7, in some embodiments, step 1041 shown in FIG. 6 may include the following steps 10411-10412, which will be explained in detail below.

10411: determining a total cost based on the cost of each of the M sampled control parameter sequences and a preset selection coefficient.

In some embodiments, the above-mentioned step 10411 may include: obtaining M products by multiplying the cost of each of the M sampling control parameter sequences with the selection coefficient; and obtaining a total cost by summing the M products.

In this embodiment, the selection coefficient may be determined according to actual needs. The selection coefficient may represent the level of the selectivity of the weighted average of the control parameter sequence. For example, the selection coefficient may be expressed using an equation of:

$$ω = - \frac{1}{λ} \qquad ( 5 )$$

where, ω is the selection coefficient; λ is the inverse parameter, which may also represent the level of the selectivity of the weighted average of the control parameter sequence. The smaller the value of the inverse parameter, the parameter sequence with the lower cost is selected, which may be set according to the actual needs, for example, it may be set to 0.3.

In some embodiments, the cost Jᵢ of each of the M sampling control parameter sequences may be multiplied by the selection coefficient to obtain the M products (i.e., ωJᵢ), and finally the total cost may be obtained by summing the M products. In addition, in order to simplify the calculation and improve the efficiency of data analysis, it may perform exponential transformation or logarithmic transformation on the M products, then sum the transformed results to obtain the total cost. For example, the obtaining the total cost by first performing exponential transformation on the M products then summing up may be expressed using an equation of:

$${J}_{sum} = {\sum }_{i = 1}^{M} exp ( ( - 1 / λ ) {J}_{i} ) \qquad ( 6 )$$

where, Jₛᵤₘ is the total cost; −1/λ is the selection coefficient; and Jᵢ is the cost of each of the M sampling control parameter sequences.

Through the foregoing technical solution, the total cost can be obtained using the selection coefficient and the cost of each of the M sampling control parameter sequences first, which provides the foundation for subsequent performing weighted average calculation based on the cost of each of the M sampling control parameter sequence, and the required needs of the motion control of the robot can be met by setting the appropriate selection coefficient to select the control parameter sequence with lower-cost.

10412: determining, based on the cost of each of the M sampled control parameter sequences and the total cost, the weight coefficient of the sampled control parameter sequences.

In some embodiments, the above-mentioned step 10412 may include: obtaining M division results by dividing each of the M products corresponding to the M sampling control parameter sequences with the total cost; and determining the M division results as the weight coefficient of each of the M sampling control parameter sequences.

In this embodiment, each of the M products (i.e., ωJᵢ) corresponding to each of the M sampling control parameter sequences are divided by the total cost to obtain M division results

$$( i . e . , \frac{ω {J}_{i}}{{\sum }_{i = 1}^{M} ω {J}_{i}} ) ,$$

and then the M division results are determined as the weight coefficient of each of the M sampling control parameter sequences. In the case that the M products are first exponentially transformed or logarithmically transformed, then the sum of the transformed results is calculated to obtain the total cost and cost, similarly, each of the M products

$$( i . e . , exp ( ( - \frac{1}{λ} ) {J}_{i} ) )$$

corresponding to each of the M sampling control parameter sequences is divided by the total cost to obtain the M division results

$$( i . e . , \frac{exp ( ( - \frac{1}{λ} ) {J}_{i} )}{{\sum }_{i = 1}^{M} exp ( ( - 1 / λ ) {J}_{i} )} ) ,$$

then each of the M division results are determined as the weight coefficient of each of the M sampling control parameter sequences.

Through the foregoing technical solution, the cost of each of the M sampling control parameter sequences obtained by random sampling can be calculated, so as to convert into the weight coefficients using the costs to facilitate the subsequent integration of the M sampling control parameter sequences to obtain the target control parameter sequence. Using Gaussian distributed sampling to solve the target control parameter sequence is a derivative-free method, which can reduce the requirements for computing power.

As shown in FIG. 6, there are steps after the above-mentioned step 1041 to be explained as follows.

1042: determining the target control parameter sequence based on the weight coefficients of the M sampled control parameter sequences and the M sampled control parameter sequences.

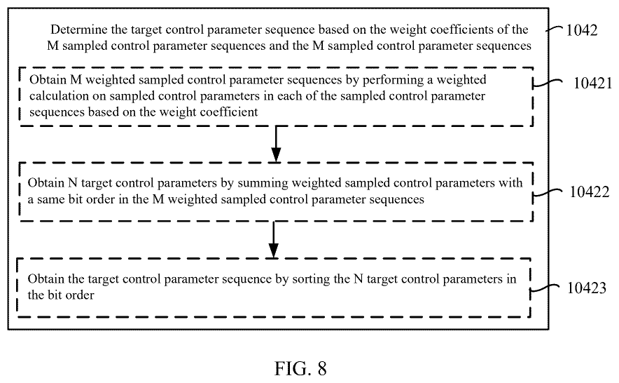

FIG. 8 is a flow chart of determining a target control parameter sequence according to another embodiment of the present disclosure. Step 1042 shown in FIG. 6 may include the following steps 10421-10423, which will be explained in detail below.

10421: obtaining M weighted sampled control parameter sequences by performing a weighted calculation on sampled control parameters in each of the sampled control parameter sequences based on the weight coefficient.

In this embodiment, the weight coefficient and each sampling control parameter of each sampling control parameter sequence are weighted to obtain the M weighted sampling control parameter sequences. For example, with regard to the first among the M sampling control parameter sequences, the weight coefficient of the first sampling control parameter sequence is

$$\frac{exp ( ( - \frac{1}{λ} ) {J}_{1} )}{{\sum }_{i = 1}^{M} exp ( ( - 1 / λ ) {J}_{i} )} ,$$

and the weight coefficient and each sampling control parameter are weighted to obtain

$$[ \frac{exp ( ( - \frac{1}{λ} ) {J}_{1} )}{{\sum }_{i = 1}^{M} exp ( ( - 1 / λ ) {J}_{i} )} {u}_{1 , 0} , \frac{exp ( ( - \frac{1}{λ} ) {J}_{1} )}{{\sum }_{i = 1}^{M} exp ( ( - 1 / λ ) {J}_{i} )} {u}_{1 , 1} , … … , \frac{exp ( ( - \frac{1}{λ} ) {J}_{1} )}{{\sum }_{i = 1}^{M} exp ( ( - 1 / λ ) {J}_{i} )} {u}_{1 , N - 1} ]$$

(u_{1,0} represents the control parameter corresponding to the initial moment in the first sampling control parameter sequence), which may also be expressed as

$$\frac{exp ( ( - \frac{1}{λ} ) {J}_{1} )}{{\sum }_{i = 1}^{M} exp ( ( - 1 / λ ) {J}_{i} )} {U}_{1} .$$

Repeat the foregoing steps to obtain the M weighted sampling control parameter sequences

$$( i . e . , \frac{exp ( ( - \frac{1}{λ} ) {J}_{i} )}{{\sum }_{i = 1}^{M} exp ( ( - 1 / λ ) {J}_{i} )} {U}_{i} ) .$$

10422: obtaining N target control parameters by summing weighted sampled control parameters with a same bit order in the M weighted sampled control parameter sequences.

In this embodiment, the historical control parameters may be arranged in the order of time within the time step in the historical control parameter sequence. Similarly, the weighted sampling control parameters may also be arranged in the order of time within the time step in the weighted sampling control parameter sequence. The M weighted sampling control parameters with the same bit order in the M weighted sampling control parameter sequences are summed to obtain the target control parameters of the corresponding bit order. Each weighted sampling control parameter sequence has N weighted sampling control parameters, and finally N target control parameters are obtained.

Below, it will be explained by taking two weighted sampling control parameter sequences each including 3 weighted sampling control parameters, that is, [α₁u_{1,0},α₁u_{1,1},α₁u_{1,3}], [α₂u_{2,0},α₂u_{2,1},α₂u_{2,3}], α₁ is the weight coefficient of the first weighted sampling control parameter sequence, and α₂ is the weight coefficient of the second weighted sampling control parameter sequence), as an example. The target control parameter of the first bit order is α₁u_{1,0}+α₂u_{2,0}, the target control parameter of the second bit order is α₁u_{1,1}+α₂u_{2,1}, and the target control parameter of the third bit order is α₁u_{1,3}+α₂u_{2,3}.

10423: obtaining the target control parameter sequence by sorting the N target control parameters in the bit order.

In this embodiment, the obtained N target control parameters may be sorted according to the time order of the weighted sampling control parameters within the time step to obtain the target control parameter sequence. Again, it will be explained by taking two weighted sampling control parameter sequences each including 3 weighted sampling control parameters as an example. After summing, it obtains the target control parameters of the first bit order as α₁u_{1,0}+α₂u_{2,0}, the target control parameters in the second bit order as α₁u_{1,1}+α₂u_{2,1}, and the target control parameters in the third bit order as α₁u_{1,3}+α₂u_{2,3}. By sorting according to the time order of the weighted sampling control parameters within the time step, it obtains [α₁u_{1,0}+α₂u_{2,0}, α₁u_{1,1}+α₂u_{2,1}, α₁u_{1,3}+α₂u_{2,3}].

Through steps 10421-10423, after converting the cost of each of the M sample control parameter sequences into the weight coefficient, the M sample control parameter sequences are integrated to obtain the target control parameter sequence, thereby obtaining the optimal control parameter sequence under the Gaussian distributed sampling which can meet the required needs of the motion control of the robot.

As shown in FIG. 3, there are steps after the above-mentioned step 104 to be explained as follows.

105: performing, according to the target control parameter sequence, a motion control on the robot.

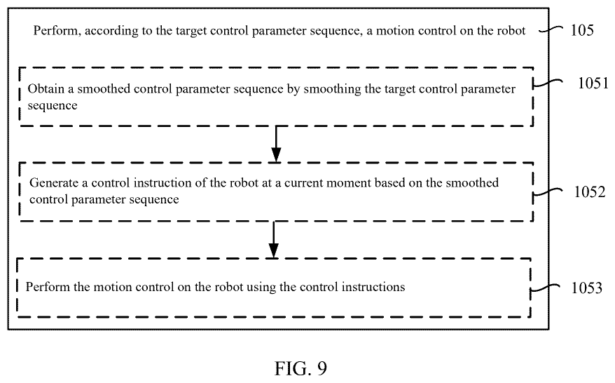

FIG. 9 is a flow chart of performing a motion control on the robot according to an embodiment of the present disclosure. Step 105 shown in FIG. 3 may include the following steps 1051-1053, which will be explained in detail below.

1051: obtaining a smoothed control parameter sequence by smoothing the target control parameter sequence.

In this embodiment, by smoothing the target control parameter sequence, it may eliminate short fluctuations caused by noise or other interference factors, thereby obtaining the more stable target control parameter sequence. The means for smoothing may include: sliding average (smoothing the data by calculating the average of all values within a given time window), moving average (calculating the median value in a given time window), Brooks filter (a very robust smoothing technology that can handle random noise and trends at the same time), or the like.

For example, if the target control parameter sequence is u=[1, 3, 2, 5, 2, 4, 6, 3, 5, 2], and the sliding average means is used for smoothing, assuming the window size is n=3, then the smoothed sequence will be y=[3, 3, 3, 3.5, 3.5, 4, 4.5, 4, 4, 3].

1052: generating a control instruction of the robot at a current moment based on the smoothed control parameter sequence.

In this embodiment, it may generate the control instructions of the robot at the current moment based on the control parameters in the smoothed control parameter sequence. Assuming that the smoothed control parameter sequence is [u₀, u₁, u₂], where u₀=[0.5,0.1], u₁=[0.5,0], and u₂=[0.4,−0.1], it should be noted that the first smooth control parameter in the smoothed control parameter sequence represents the linear velocity of the movement of the robot, where a positive linear velocity indicates forward movement, a negative linear velocity indicates backward movement, and a zero linear velocity indicates stilling; and the second smooth control parameter represents the angular velocity of the movement of the robot, where a positive angular velocity indicates a right turn, a negative angular velocity indicates a left turn, and a zero angular velocity indicates no turn. Then, at the initial moment within the time step, the robot begins moving, u₀=[0.5,0.1], meaning a linear velocity of 0.5 m/s, a right turn, and an angular velocity of 0.1 rad/s. Then, based on the parameters of u₀, it may generate the control instruction for the robot to move forward and turn right. At the second moment within the time step, u₁=[0.5,0], meaning the linear velocity is 0.5 m/s, a straight movement, and an angular velocity of 0. And then, it may generate the control instruction for the robot to continue moving straight ahead based on the parameters of u₁. At the third moment within the time step, u₂=[0.4,−0.1]], meaning a linear velocity of 0.4 m/s, a left turn, and an angular velocity of 0.1 rad/s. Finally, it may generate the control instruction for the robot to move forward and turn left based on the parameters of u₂.

1053: performing the motion control on the robot using the control instructions.

In this embodiment, the motion control may be performed on the robot through the generated control instruction. For example, three control instructions can be generated based on the smoothed control parameter sequence [u₀, u₁, u₂]. First, it needs to perform the motion control on the robot according to the control instruction corresponding to the initial moment within the time step by, for example, enabling the robot to move forward and turn right at a linear speed of 0.5 m/s and an angular speed of 0.1 rad/s.

In one embodiment, when the second moment within the time step is reached, it may continue to use the control instruction corresponding to the second moment to control the robot; and when the third moment within the time step is reached, it may continue to use the control instruction corresponding to the third moment to control the robot. Then, the foregoing steps may be repeated to redetermine the target control parameter sequence so as to generate the control instruction corresponding to the initial moment, second moment, and third moment within a new time step, until the robot reaches a target position. In this way, by determining the control instructions for a plurality of moments within one time step and using these control instructions to control the robot in sequence, it can calculate the control instructions for a period of time (i.e., within one time step) at one moment of the present. Since the movement speed of the robot is limited, even if multiple control instructions are determined at one time, the control accuracy of the robot will not be reduced, while this control method can greatly reduce the amount of data calculation, thereby greatly saving computing resources and improving control efficiency.

In another embodiment, when the second moment within the time step is reached, the robot may no longer execute the control instruction corresponding to the second moment within the time step. In this case, it is necessary to repeat the foregoing steps to redetermine the target control parameter sequence, generate the control instruction corresponding to the initial moment within the time step, until the robot reaches the target position. In this way, after the robot executes the control instruction corresponding to the initial moment within the time step, since the robot can collect new status information and environment information, the subsequent movement of the robot may be adjusted according to the actual situation by using these new information to re-predict (rather than directly continuing to control the robot with the control instruction at the second moment), thereby achieving more accurate and real-time control of the robot.

Through steps 1051-1053, the target control parameter sequence can be smoothed to reduce high-frequency noise and jitter in the target control parameter sequence, making the robot more stable when being moved according to the control instructions.

In this embodiment, it can construct the Gaussian distribution of the control parameters of the robot using the historical control parameter sequence of the robot within the historical time step, then randomly sampling the Gaussian distribution to obtain the M sample control parameter sequences. With help of the nature of the Gaussian distribution that makes most of the sampled values of the sampling control parameter sequence concentrated near the historical control parameter sequence, it reduces the possibility that the control parameters of the robot suddenly change to extreme values that may cause motion instability, thereby ensuring the stability of the motion of the robot. Then, it uses the pre-constructed cost equation to determine the cost of each of the M sample control parameter sequences, determine the target control parameter sequence based on the cost and the M sample control parameter sequences, and finally control the robot to move according to the target control parameter sequence. By sampling the Gaussian distribution and determining the target control parameter sequence through the sampling control parameter sequence, it can reduce the computing power for solving the optimal control parameter sequence of the robot without calculating derivatives, thereby improving the efficiency of the motion control of robot.

An example of applying this embodiment in a practical application scenario will be described as follows.

In this embodiment, it makes use of the principle of MPC to construct an optimization equation through the prediction information of the robot in moving horizon. The optimization equation may be expressed using an equation of:

$$U = arg min ( J ) \qquad ( 7 )$$

where, U is the control parameter sequence of the robot which is as equation (1); and J is the cost equation which is as equation (4).

In the existing methods, the optimal control parameter sequence U is obtained by solving the optimization equation (7). However, for nonlinear systems, solving the foregoing optimization equation based on gradients is very computational and has high computing power requirements. In contrast, in this embodiment, it is solved by sampling the Gaussian distribution solution-a derivative-free method which can be applied to highly nonlinear and non-convex functions. The details will be explained as follows.

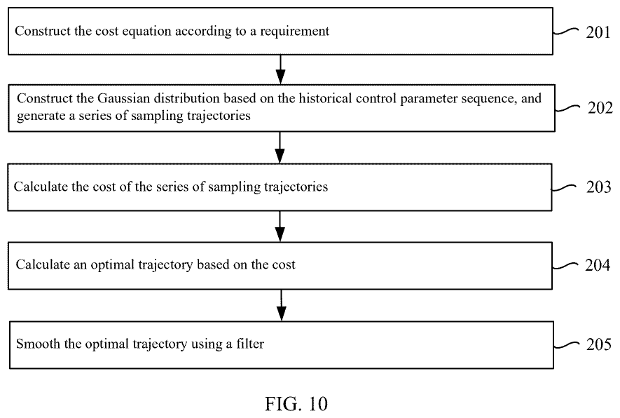

FIG. 10 is a flow chart of solving an optimization equation according to an embodiment of the present disclosure. As shown in FIG. 10, it explains by taking a server as the subject of execution

201: constructing the cost equation according to a requirement. The details of step 201 may refer to step 103, and the expression of the cost equation may be referred to equation (4).

202: constructing the Gaussian distribution based on the historical control parameter sequence, and generating a series of sampling trajectories.

First, each historical control parameter in the historical control parameter sequence of the historical time step is used as a desired value, while a preset standard deviation is set in advance to, for example, 0.4, thereby constructing N Gaussian distributions. Then, the M sampling control parameter sequences Uᵢ (i.e., the sampling trajectory) of the robot is drawn in parallel by sampling the Gaussian distribution.

203: calculating the cost of the series of sampling trajectories. The M sampling control parameter sequences Uᵢ of the robot are successively substituted into equation (4) to calculate the cost Jᵢ of each sampling control parameter sequence Uᵢ.

204: calculating an optimal trajectory based on the cost.

The cost Jᵢ of each sampling control parameter sequence is converted into the weight coefficient, and the M sampling control parameter sequences are integrated to obtain the optimal trajectory (i.e., the target control parameter sequence). Since the lower the cost, the more the control parameter sequence meets the needs of the target task, the cost is used as the weight coefficient to integrate the M sampling trajectories into an optimal trajectory. The optimal trajectory can be understood as the optimal trajectory under sampling while it is not globally optimal but can meet the target requirements of motion control. The calculation of the target control parameter sequence may be expressed using an equation of:

$${U}_{opt} = \frac{{\sum }_{i = 1}^{M} exp ( ( - 1 / λ ) {J}_{i} ) {U}_{i}}{{\sum }_{i = 1}^{M} exp ( ( - 1 / λ ) {J}_{i} )} \qquad ( 8 )$$

where, Uₒₚₜ is the target control parameter sequence; Uᵢ are the M sampling control parameter sequences of the robot; Jᵢ is the cost of the M sampling control parameter sequences; and λ is the reverse parameter which represents the level of the selectivity of the weighted average of the trajectory, where the smaller the value, the lower the cost of the selected control parameter sequence is. Generally, λ is set to 0.3.

205: smoothing (i.e., smooth filtering) the optimal trajectory using a filter. The optimal trajectory (i.e., the target control parameter sequence) may be smoothed using the Savetsky-Golli (SG) filter. The SG filter smooths signals by performing polynomial fitting on data points and sliding a fixed window over the entire data set. First, a window size—a positive or odd number is determined, and the order of the polynomial for fitting the control parameters within the window is determined (the higher the order of the polynomial, the more precise the fitting is, but it is also more susceptible to noise). Second, the window is moved to the beginning of the target control parameter sequence, the selected order of the polynomial is used to perform polynomial fitting on the control parameters within the window, and the polynomial obtained by fitting is used to calculate the value of the polynomial. Finally, the value of the polynomial is used to replace the control parameter corresponding to the center of the window, thereby obtaining the smoothed control parameters. Subsequently, the window is moved to repeat the foregoing steps until the window covers the entire target control parameter sequence, then the smoothed target control parameter sequence is outputted.

The example of applying this embodiment in another practical application scenario will be described as follows.

Assuming that there is an autonomous robot to perform a task of moving goods to a shelf marked “A” in a crowded warehouse where having multiple robots operate simultaneously and human workers move around-a complex and dynamically changing environment. First, it needs to determine the various cost factors that construct the cost equation: position cost (which measures the distance and orientation deviations between the robot and the target), dynamic cost (which measures the response of the robot to dynamic obstacles), distance cost (which ensures the robot maintains a safe distance from other robots), and precision cost (which ensures the accuracy of the posture of the robot when reaching the target). These cost factors are weighted and summed to form a comprehensive cost equation. Then, as in steps 101-104, the target control parameter sequence of the autonomous robot is determined, and as in steps 1051-1052, the control instruction for the autonomous robot at the current moment is determined. Furthermore, after the autonomous robot completes executing the control instruction corresponding to the initial moment within the time step and the second moment within the time step is reached, it uses its sensors (e.g., camera, Lidar, and ultrasonic sensor) to perceive the surrounding environment (e.g., the location of shelf, the positions of other robots and staff, and dynamic obstacles) in real time. Based on the perceived environmental data, it updates the corresponding parameters in the cost equation. Finally, it uses the updated cost equation to regenerate the control instruction corresponding to the initial moment within the time step. These steps are repeated until the autonomous robot reaches the storage shelf marked “A”. In this manner, the autonomous robot can respond to environmental changes in real time in complex dynamic environments and adjust its motion behavior to adapt to environmental uncertainties.

In this embodiment, it can avoid solving multi-dimensional optimization problems by utilizing the multi-objective optimization equation constructed by realizing MPC through sampling the Gaussian distribution, thereby improving the control efficiency, and can conduct the robot to move freely in a complex three-dimensional complex space by smooth filtering the output target control parameter sequence. The safe and stable movement of the autonomous robot in a complex and dynamic environment can be realized, so that it can reach the target pose point while uncertainties in the environment can be coped with, and has the ability to interact with other intelligent entities while the high computing power requirements are not required and therefore possible to be well deployed on the actual robot.

In the embodiments of the present disclosure, a robot control apparatus 543 implemented as software modules is also provided. As shown in FIG. 2, in some embodiments, the robot control apparatus 543 stored in the storage 540 may include:
a construction module 5431 configured to construct, based on a historical control parameter sequence of the robot within a historical time step, a Gaussian distribution of control parameters of the robot; a sampling module 5432 configured to obtain, by randomly sampling the Gaussian distribution, M sampling control parameter sequences, where M is an integer larger than 1; a cost determination module 5433 configured to determine, based on a pre-built cost equation for a motion trajectory of the robot, a cost of each of the M sampling control parameter sequences; a parameter sequence determination module 5434 configured to determine, based on the cost of each of the M sampling control parameter sequence and the M sampling control parameter sequences, a target control parameter sequence; and a control module 5435 configured to perform, according to the target control parameter sequence, a motion control on the robot

In some embodiments, the construction module 5431 may further configure to: obtain a preset standard deviation; determine each historical control parameter in the historical control parameter sequence as a desired value, where the historical control parameter sequence includes N historical control parameters, and N is an integer larger than 1; and construct, based on the desired value and the preset standard deviation, N Gaussian distributions of the control parameters of the robot.

In some embodiments, the sampling module 5432 may further configure to: obtaining N sampling control parameters by randomly sampling the Gaussian distribution in each random sampling; and obtaining one of the M sampling control parameter sequences by sorting the N sampling control parameters according to an arrangement order of historical control parameters in the historical control parameter sequence that correspond to the Gaussian distribution.

In some embodiments, the parameter sequence determination module 5434 may further configure to: determining, based on the cost of each of the M sampled control parameter sequence, a weight coefficient of the sampled control parameter sequences; and determining the target control parameter sequence based on the weight coefficients of the M sampled control parameter sequences and the M sampled control parameter sequences.

In some embodiments, the parameter sequence determination module 5434 may further configure to: determining a total cost based on the cost of each of the M sampled control parameter sequences and a preset selection coefficient; and determining, based on the cost of each of the M sampled control parameter sequences and the total cost, the weight coefficient of the sampled control parameter sequences.

In some embodiments, the parameter sequence determination module 5434 may further configure to: obtain M products by multiplying the cost of each of the M sampled control parameter sequences with the selection coefficient; and obtaining the total cost by summing the M products.

In some embodiments, the parameter sequence determination module 5434 may further configure to: obtaining M division results by dividing each of the M products corresponding to the M sampled control parameter sequences with the total cost; and determining the M division results as the weight coefficients of each of the M sampled control parameter sequences.

In some embodiments, the parameter sequence determination module 5434 may further configure to: obtaining M weighted sampled control parameter sequences by performing a weighted calculation on sampled control parameters in each of the sampled control parameter sequences based on the weight coefficient; obtaining N target control parameters by summing weighted sampled control parameters with a same bit order in the M weighted sampled control parameter sequences; and obtaining the target control parameter sequence by sorting the N target control parameters in the bit order.

In some embodiments, the control module 5435 may further configure to: obtaining a smoothed control parameter sequence by smoothing the target control parameter sequence; generating a control instruction of the robot at a current moment based on the smoothed control parameter sequence; and performing the motion control on the robot using the control instructions.

The embodiments of the present disclosure further provide a computer program product including computer programs or computer executable instructions that are stored in a computer-readable storage medium. The processor of an electronic device reads the computer-executable instructions from the computer-readable storage medium, then executes the computer-executable instructions to perform the above-mentioned robot control method.

The embodiments of the present disclosure further provide a computer-readable storage medium storing computer-executable instructions or computer programs. When the computer-executable instructions or computer programs are executed by a processor, a robot control method provided by the embodiment of the present disclosure like the robot control method as shown in FIG. 3 will be performed.

In some embodiments, the computer-readable storage medium may be RAM, ROM, flash memory, magnetic surface memory, optical disk, CD-ROM, or other storage, and may also be various devices including one or any combination of the above-mentioned storages.

In some embodiments, the computer-executable instructions may be implemented in the form of a program, software, software module, script or codes in any form of programming language (including compiled or interpreted languages, or declarative or procedural languages), and may be deployed in any form, including being deployed as a standalone program, a module, a component, a subroutine, or other unit suitable for use in a computing environment.

For example, the computer-executable instructions may, but do not necessarily correspond to a file in the file system, and may be stored in a part of the file storing other programs or data, for example, in one or more scripts of a Hyper Text Markup Language (HTML) document, or stored in a single file dedicated to the program in question, or a plurality of collaborative files (e.g., files that store one or more modules, subroutines, or code parts).

For example, the computer-executable instructions may be deployed to execute on one electronic device, or on a plurality of electronic devices located at one location, or a plurality of electronic devices distributed across multiple locations and interconnected over a communication network.

In summary, through the embodiments of the present disclosure, it can construct the Gaussian distribution of the control parameters of the robot using the historical control parameter sequence of the robot within the historical time step, then randomly sampling the Gaussian distribution to obtain the M sample control parameter sequences. With help of the nature of the Gaussian distribution that makes most of the sampled values of the sampling control parameter sequence concentrated near the historical control parameter sequence, it reduces the possibility that the control parameters of the robot suddenly change to extreme values that may cause motion instability, thereby ensuring the stability of the motion of the robot. Then, it uses the pre-constructed cost equation to determine the cost of each of the M sample control parameter sequences, determine the target control parameter sequence based on the cost and the M sample control parameter sequences, and finally control the robot to move according to the target control parameter sequence. In which, by sampling the Gaussian distribution and determining the target control parameter sequence through the sampling control parameter sequence, it can reduce the computing power for solving the optimal control parameter sequence of the robot without calculating derivatives, thereby improving the efficiency of the motion control of robot; M sampling control parameter sequence can be randomly generated by performing random sampling on the Gaussian distribution. Subsequently, the optimal robot control parameter sequence can be solved using the M sampling control parameter sequences, thereby further reducing the computing power for solving the optimal control parameter sequence of the robot; the total cost can be obtained using the selection coefficient and the cost of each of the M sampling control parameter sequences first, which provides the foundation for subsequent performing weighted average calculation based on the cost of each of the M sampling control parameter sequence, and the required needs of the motion control of the robot can be met by setting the appropriate selection coefficient to select the control parameter sequence with lower-cost; the cost of each of the M sampling control parameter sequences obtained by random sampling can be calculated, so as to convert into the weight coefficients using the costs to facilitate the subsequent integration of the M sampling control parameter sequences to obtain the target control parameter sequence, which can reduce the requirements for computing power; and after converting the cost of each of the M sample control parameter sequences into the weight coefficient, the M sample control parameter sequences are integrated to obtain the target control parameter sequence, thereby obtaining the optimal control parameter sequence under the Gaussian distributed sampling which can meet the required needs of the motion control of the robot. In addition, the target control parameter sequence can be smoothed to reduce high-frequency noise and jitter in the target control parameter sequence, making the robot more stable when being moved according to the control instructions. Furthermore, it can avoid solving multi-dimensional optimization problems by utilizing the multi-objective optimization equation constructed by realizing MPC through sampling the Gaussian distribution, thereby improving the control efficiency, and can conduct the robot to move freely in a complex three-dimensional complex space by smooth filtering the output target control parameter sequence. The safe and stable movement of the autonomous robot in a complex and dynamic environment can be realized, so that it can reach the target pose point while uncertainties in the environment can be coped with, and has the ability to interact with other intelligent entities while the high computing power requirements are not required and therefore possible to be well deployed on the actual robot.

The foregoing are only the embodiments of the present disclosure and are not intended to limit the scope of the protection of the present disclosure. Any modification, equivalent substitution, improvement, and the like made within the spirit and scope of the present disclosure are included within the scope of the protection of the present disclosure.

What is claimed is:

1. A method for controlling a robot, comprising:
constructing, based on a historical control parameter sequence of the robot within a historical time step, a Gaussian distribution of control parameters of the robot;
obtaining, by randomly sampling the Gaussian distribution, M sampling control parameter sequences, wherein M is an integer larger than 1;
determining, based on a pre-built cost equation for a motion trajectory of the robot, a cost of each of the M sampling control parameter sequences;
determining, based on the cost of each of the M sampling control parameter sequences and the M sampling control parameter sequences, a target control parameter sequence; and
performing, according to the target control parameter sequence, a motion control on the robot.

2. The method of claim 1, wherein constructing, based on the historical control parameter sequence of the robot within the historical time step, a Gaussian distribution of control parameters of the robot comprises:
obtaining a preset standard deviation;
determining each historical control parameter in the historical control parameter sequence as a desired value, wherein the historical control parameter sequence includes N historical control parameters, and N is an integer larger than 1; and
constructing, based on the desired value and the preset standard deviation, N Gaussian distributions of the control parameters of the robot.

3. The method of claim 1, wherein obtaining, by randomly sampling the Gaussian distribution, the M sampling control parameter sequences comprises:
obtaining N sampling control parameters by randomly sampling the Gaussian distribution in each random sampling; and
obtaining one of the M sampling control parameter sequences by sorting the N sampling control parameters according to an arrangement order of historical control parameters in the historical control parameter sequence that correspond to the Gaussian distribution.

4. The method of claim 1, wherein determining, based on the pre-built cost equation for the motion trajectory of the robot, the cost of each of the M sampling control parameter sequences comprises:
simulating M robot trajectories, based on the M sampling control parameter sequences, using a first-order system; and
determining, based on the M sampling control parameter sequences and the simulated M robot trajectories, the cost of each of the M sampling control parameter sequences.

5. The method of claim 4, wherein determining, based on the cost of each of the M sampling control parameter sequences and the M sampling control parameter sequences, the target control parameter sequence comprises:
determining, based on the cost of each of the M sampled control parameter sequence, a weight coefficient of the sampled control parameter sequences; and
determining the target control parameter sequence based on the weight coefficients of the M sampled control parameter sequences and the M sampled control parameter sequences.

6. The method of claim 5, wherein determining, based on the cost of each of the M sampled control parameter sequence, the weight coefficient of the sampled control parameter sequences comprises:
determining a total cost based on the cost of each of the M sampled control parameter sequences and a preset selection coefficient; and
determining, based on the cost of each of the M sampled control parameter sequences and the total cost, the weight coefficient of the sampled control parameter sequences.

7. The method of claim 6, wherein determining a total cost based on the cost of each of the M sampled control parameter sequences and a preset selection coefficient comprises:
obtain M products by multiplying the cost of each of the M sampled control parameter sequences with the selection coefficient; and
obtaining the total cost by summing the M products.

8. The method of claim 7, wherein determining, based on the cost of each of the M sampled control parameter sequences and the total cost, the weight coefficient of the sampled control parameter sequences comprises:
obtaining M division results by dividing each of the M products corresponding to the M sampled control parameter sequences with the total cost; and
determining the M division results as the weight coefficients of each of the M sampled control parameter sequences.

9. The method of claim 5, wherein determining the target control parameter sequence based on the weight coefficients of the M sampled control parameter sequences and the M sampled control parameter sequences comprises:
obtaining M weighted sampled control parameter sequences by performing a weighted calculation on sampled control parameters in each of the sampled control parameter sequences based on the weight coefficient;
obtaining N target control parameters by summing weighted sampled control parameters with a same bit order in the M weighted sampled control parameter sequences; and
obtaining the target control parameter sequence by sorting the N target control parameters in the bit order.

10. The method of claim 1, wherein performing, according to the target control parameter sequence, the motion control on the robot comprises:
obtaining a smoothed control parameter sequence by smoothing the target control parameter sequence;
generating a control instruction of the robot at a current moment based on the smoothed control parameter sequence; and
performing the motion control on the robot using the control instructions.

11. A robot, comprising:
a processor;
a memory coupled to the processor; and
one or more computer programs stored in the memory and executable on the processor;
wherein, the one or more computer programs comprise:
instructions for constructing, based on a historical control parameter sequence of the robot within a historical time step, a Gaussian distribution of control parameters of the robot;
instructions for obtaining, by randomly sampling the Gaussian distribution, M sampling control parameter sequences, wherein M is an integer larger than 1;
instructions for determining, based on a pre-built cost equation for a motion trajectory of the robot, a cost of each of the M sampling control parameter sequences;
instructions for determining, based on the cost of each of the M sampling control parameter sequences and the M sampling control parameter sequences, a target control parameter sequence; and
instructions for performing, according to the target control parameter sequence, a motion control on the robot.

12. The robot of claim 11, wherein the instructions for constructing, based on the historical control parameter sequence of the robot within the historical time step, a Gaussian distribution of control parameters of the robot comprise:
instructions for obtaining a preset standard deviation;
instructions for determining each historical control parameter in the historical control parameter sequence as a desired value, wherein the historical control parameter sequence includes N historical control parameters, and N is an integer larger than 1; and
instructions for constructing, based on the desired value and the preset standard deviation, N Gaussian distributions of the control parameters of the robot.

13. The robot of claim 11, wherein the instructions for obtaining, by randomly sampling the Gaussian distribution, the M sampling control parameter sequences comprise:
instructions for obtaining N sampling control parameters by randomly sampling the Gaussian distribution in each random sampling; and
instructions for obtaining one of the M sampling control parameter sequences by sorting the N sampling control parameters according to an arrangement order of historical control parameters in the historical control parameter sequence that correspond to the Gaussian distribution.

14. The robot of claim 11, wherein determining, based on the pre-built cost equation for the motion trajectory of the robot, the cost of each of the M sampling control parameter sequences comprises:
simulating M robot trajectories, based on the M sampling control parameter sequences, using a first-order system; and
determining, based on the M sampling control parameter sequences and the simulated M robot trajectories, the cost of each of the M sampling control parameter sequences.

15. The robot of claim 11, wherein the instructions for determining, based on the cost of each of the M sampling control parameter sequences and the M sampling control parameter sequences, the target control parameter sequence comprise:
instructions for determining, based on the cost of each of the M sampled control parameter sequence, a weight coefficient of the sampled control parameter sequences; and
instructions for determining the target control parameter sequence based on the weight coefficients of the M sampled control parameter sequences and the M sampled control parameter sequences.

16. The robot of claim 15, wherein the instructions for determining, based on the cost of each of the M sampled control parameter sequence, the weight coefficient of the sampled control parameter sequences comprise:
instructions for determining a total cost based on the cost of each of the M sampled control parameter sequences and a preset selection coefficient; and
instructions for determining, based on the cost of each of the M sampled control parameter sequences and the total cost, the weight coefficient of the sampled control parameter sequences.

17. The robot of claim 16, wherein the instructions for determining a total cost based on the cost of each of the M sampled control parameter sequences and a preset selection coefficient comprise:
instructions for obtain M products by multiplying the cost of each of the M sampled control parameter sequences with the selection coefficient; and
instructions for obtaining the total cost by summing the M products.

18. The robot of claim 17, wherein the instructions for determining, based on the cost of each of the M sampled control parameter sequences and the total cost, the weight coefficient of the sampled control parameter sequences comprise:
instructions for obtaining M division results by dividing each of the M products corresponding to the M sampled control parameter sequences with the total cost; and
instructions for determining the M division results as the weight coefficients of each of the M sampled control parameter sequences.

19. The robot of claim 15, wherein the instructions for determining the target control parameter sequence based on the weight coefficients of the M sampled control parameter sequences and the M sampled control parameter sequences comprise:
instructions for obtaining M weighted sampled control parameter sequences by performing a weighted calculation on sampled control parameters in each of the sampled control parameter sequences based on the weight coefficient;
instructions for obtaining N target control parameters by summing weighted sampled control parameters with a same bit order in the M weighted sampled control parameter sequences; and
instructions for obtaining the target control parameter sequence by sorting the N target control parameters in the bit order.

20. A non-transitory computer-readable storage medium for storing one or more computer programs, wherein the one or more computer programs comprise:
instructions for constructing, based on a historical control parameter sequence of a robot within a historical time step, a Gaussian distribution of control parameters of the robot;
instructions for obtaining, by randomly sampling the Gaussian distribution, M sampling control parameter sequences, wherein M is an integer larger than 1;
instructions for determining, based on a pre-built cost equation for a motion trajectory of the robot, a cost of each of the M sampling control parameter sequences;
instructions for determining, based on the cost of each of the M sampling control parameter sequences and the M sampling control parameter sequences, a target control parameter sequence; and
instructions for performing, according to the target control parameter sequence, a motion control on the robot.
